(19) United States
(12) Patent Application Publication
(10) Pub. No.: US 2018/0048815 A1
(43) Pub. Date: Feb. 15, 2018

(54) MOBILE TERMINAL AND OPERATING METHOD THEREOF

(71) Applicant: LG ELECTRONICS INC., Seoul (KR)

(72) Inventors: Eunhye KIM, Seoul (KR); Taeyoung JEON, Seoul (KR)

(73) Assignee: LG ELECTRONICS INC., Seoul (KR)

(21) Appl. No.: 15/416,260

(22) Filed: Jan. 26, 2017

(30) Foreign Application Priority Data
Aug. 12, 2016 (KR) 10-2016-0103030

(51) Int. Cl. H04N 5/232; H04N 5/247

(52) U.S. Cl. CPC H04N 5/23238; H04N 5/247; H04N 5/23293; H04N 5/23241; H04N 5/23296; H04N 5/23216; H04N 5/23203

(57) ABSTRACT

A mobile terminal a display; a camera configured to photograph an image of a subject; a short-range communication processor configured to receive an omnidirectional image from an omnidirectional photographing device; and a controller configured to detect a camera change condition, change a main agent of photographing the subject to any one of the camera and the omnidirectional photographing device in response to the detected camera change condition, and display an image photographed by the camera or the omnidirectional photographing device, which is changed as the main agent of photographing the subject, through the display

### CROSS-REFERENCE TO THE RELATED APPLICATIONS

This application claims priority under 35 U.S.C. § 119 and § 365 to Korean Patent Application No. 10-2016-0103030, filed on Aug. 12, 2016, in the Korean Intellectual Property Office, the disclosure of which is incorporated herein by reference.

### BACKGROUND OF THE INVENTION

### Field of the Invention

The present invention relates to a mobile terminal, and more particularly, to a mobile terminal capable of performing an automatic conversion between a photographing device for photographing omnidirectional images and a camera provided in the mobile terminal.

### Description of the Related Art

Terminals may be generally classified as mobile/portable terminals or stationary terminals. Mobile terminals may also be classified as handheld terminals or vehicle mounted terminals.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device.

Recently, the mobile terminal can be used to be interlocked with a photographing device for photographing omnidirectional images. A general camera photographs a two-dimensional image, but a 360-degree camera (omnidirectional photographing device) can photograph a three-dimensional space as a spherical omnidirectional image. The photographed omnidirectional image is transmitted to the mobile terminal, to be displayed on a display.

The 360-degree camera can photograph an omnidirectional image, but the photographed image is distorted as coming close to an edge thereof. A camera provided in the mobile terminal can perform elaborate photographing. However, since the camera has a fixed angle of view, the camera cannot photograph an omnidirectional background.

### SUMMARY OF THE INVENTION

Accordingly, an object of the present invention is to address the above-noted and other problems.

Another object of the present invention is to provide a mobile terminal that detects an optimal situation in which photographing can be performed through each of an omnidirectional photographing device and a camera provided in the mobile terminal, and change a main agent of photographing a subject based on the detected result.

To accomplish these and other objects of the present invention, according to an aspect of the present invention, there is provided a mobile terminal including: a display unit; a camera configured to photograph an image of a subject; a short-range communication module configured to receive an omnidirectional image from an omnidirectional photographing device; and a controller configured to control the display unit, the camera, and the short-range communication module, wherein, if a camera change condition is detected, the controller changes a main agent of photographing the subject to any one of the camera and the omnidirectional photographing device, and displays an image photographed by the camera or the omnidirectional photographing device, which is changed as the main agent of photographing the subject, through the display unit.

According to another aspect of the present invention, there is provided a method for operating a mobile terminal having a camera, the method including: detecting a camera change condition; changing a main agent of photographing a subject to any one of the camera or an omnidirectional photographing device, based on the detected camera change condition; and displaying an image photographed by the camera or the omnidirectional photographing device, which is changed as the main agent of photographing the subject, through a display unit.

According to various embodiments of the present invention, it is possible to solve problems of the omnidirectional photographing device and the mobile terminal. Accordingly, it is possible to generate an optical photographing result suitable for an intention of a user.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1A is a block diagram of a mobile terminal according to an embodiment of the present invention.

FIGS. 1B and 1C are conceptual views of one example of the mobile terminal, viewed from different directions;

FIG. 2 is a conceptual view of a deformable mobile terminal according to an alternative embodiment of the present invention.

FIG. 3 is a conceptual view of a wearable mobile terminal according to another alternative embodiment of the present invention.

FIG. 4 is a conceptual view of a wearable mobile terminal according to another alternative embodiment of the present invention.

FIG. 5 is view illustrating a configuration of a mobile terminal and a photographing device according to an embodiment of the present invention.

FIG. 6 is a ladder diagram illustrating an operating method of a photographing system according to an embodiment of the present invention.

FIGS. 7A and 7B are views illustrating an example in which, if a camera change condition is detected, a main agent of photographing a subject is changed from the photographing device to the mobile terminal according to an embodiment of the present invention.

FIG. 8 is a view illustrating an example in which, if a camera change condition is detected, a main agent of photographing a subject is changed from the photographing device to the mobile terminal according to another embodiment of the present invention.

FIG. 9 is a ladder diagram illustrating an operating method of the photographing system according to another embodiment of the present invention.

FIG. 10 is a view illustrating an example in which, if a camera change condition is detected, a main agent of photographing a subject is changed from the photographing device to the mobile terminal according to another embodiment of the present invention.

FIG. 11 is a view illustrating an example in which, if a camera change condition is detected, a main subject of photographing a subject is changed from the photographing device to the mobile terminal according to another embodiment of the present invention.

FIG. 12 is a ladder diagram illustrating an operating method of the photographing system according to another embodiment of the present invention.

FIGS. 13A to 16 are views illustrating examples in which, if a camera change condition is detected, a main agent of photographing a subject is changed from the mobile terminal to the photographing device according to various embodiments of the present invention.

FIG. 17 is a view illustrating an example in which one photographing image is generated using both of the camera provided in the mobile terminal and the omnidirectional photographing device according to an embodiment of the present disclosure.

### DETAILED DESCRIPTION OF THE EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. The accompanying drawings are used to help easily understand various technical features and it should be understood that the embodiments presented herein are not limited by the accompanying drawings. As such, the present invention should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that if an element is referred to as being “connected with” another element, the element can be connected with the other element or intervening elements may also be present. In contrast, if an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

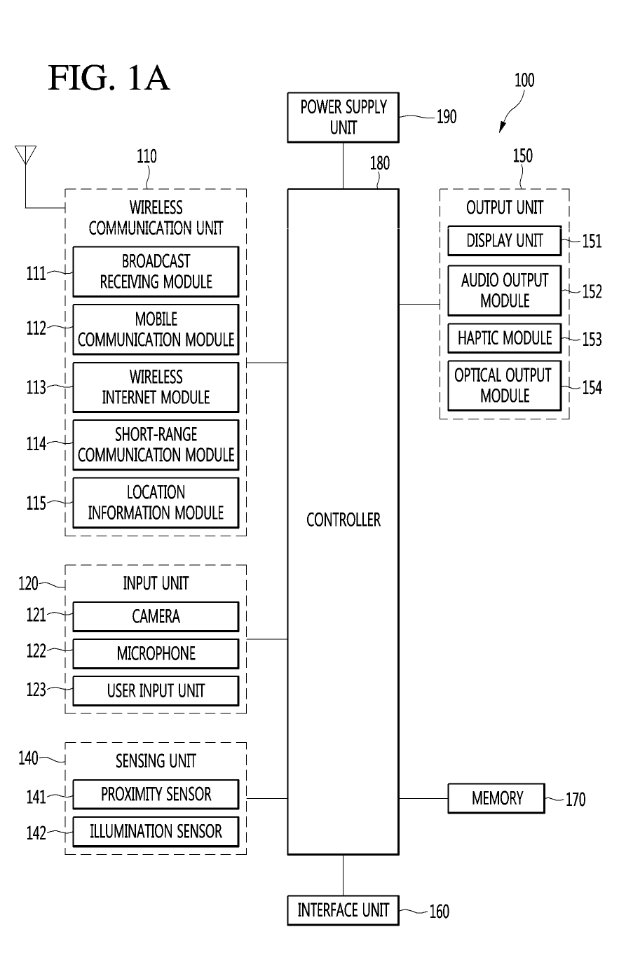

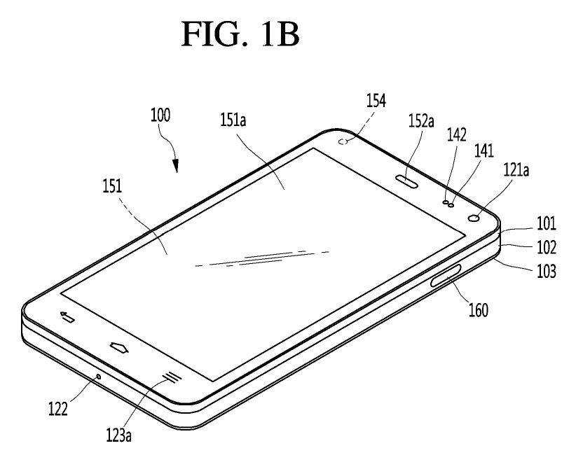

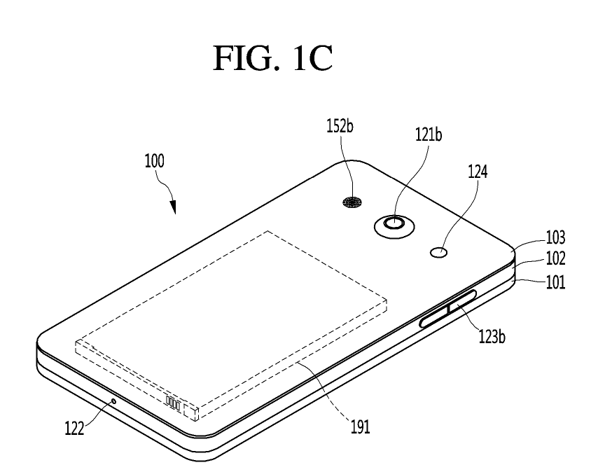

Reference is now made to FIGS. 1A-1C, where FIG. 1A is a block diagram of a mobile terminal in accordance with the present invention, and FIGS. 1B and 1C are conceptual views of one example of the mobile terminal, viewed from different directions. The mobile terminal 100 is shown having components such as a wireless communication unit 110, an input unit 120, a sensing unit 140, an output unit 150, an interface unit 160, a memory 170, a controller 180, and a power supply unit 190. Implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 can provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be a server which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this instance, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, if the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which can exchange data with the mobile terminal 100 (or otherwise cooperate with the mobile terminal 100). The short-range communication module 114 may sense or recognize the wearable device, and permit communication between the wearable device and the mobile terminal 100. In addition, if the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, if a call is received in the mobile terminal 100, the user may answer the call using the wearable device. Also, if a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, if the mobile terminal uses a GPS module, a position of the mobile terminal may be acquired using a signal sent from a GPS satellite. As another example, if the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. Further, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. If the touch screen is implemented as a capacitance type, the proximity sensor 141 can sense proximity of a pointer relative to the touch screen by changes of an electromagnetic field, which is responsive to an approach of an object with conductivity. In this instance, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

If a touch input is sensed by a touch sensor, corresponding signals may be transmitted to a touch controller. The touch controller may process the received signals, and then transmit corresponding data to the controller 180. Accordingly, the controller 180 can sense which region of the display unit 151 has been touched. Here, the touch controller may be a component separate from the controller 180, the controller 180, and combinations thereof.

In some embodiments, the controller 180 can execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor. Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented so the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

If the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 can typically control the general operations of the mobile terminal 100. For example, the controller 180 can set or release a lock state for restricting a user from inputting a control command with respect to applications if a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected. As another example, the power supply unit 190 may be configured to recharge the battery in a wireless manner without use of the connection port.

In this example, the power supply unit 190 can receive power, transferred from an external wireless power transmitter, using at least one of an inductive coupling method which is based on magnetic induction or a magnetic resonance coupling method which is based on electromagnetic resonance. Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, if the rear cover 103 is detached from the rear case 102, the electronic components mounted to the rear case 102 are externally exposed.

As illustrated, if the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like. As an alternative to the example in which the plurality of cases form an inner space for accommodating components, the mobile terminal 100 may be configured such that one case forms the inner space. In this example, a mobile terminal 100 having a uni-body is formed so synthetic resin or metal extends from a side surface to a rear surface.

If desired, the mobile terminal 100 may include a waterproofing unit for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space if those cases are coupled.

The mobile terminal includes a display unit 151, a first and a second audio output modules 151a/151b, a proximity sensor 141, an illumination sensor 142, an optical output module 154, a first and a second cameras 121a/121b, a first and a second manipulation units 123a/123b, a microphone 122, interface unit 160 and the like.

The display unit 151, the first audio output module 151a, the proximity sensor 141, an illumination sensor 142, the optical output module 154, the first camera 121a and the first manipulation unit 123a are arranged in front surface of the terminal body, the second manipulation unit 123b, the microphone 122 and interface unit 160 are arranged in side surface of the terminal body, and the second audio output modules 151b and the second camera 121b are arranged in rear surface of the terminal body.

However, alternative arrangements are possible and within the teachings of the instant invention. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. If a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like. The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this instance, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. If a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof. Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger if the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” If the second camera 121b is implemented as an array camera, images may be captured in various manners using the plurality of lenses and images with better qualities.

As shown in FIG. 1C, a flash 124 is shown adjacent to the second camera 121b. If an image of a subject is captured with the camera 121b, the flash 124 may illuminate the subject. As shown in FIG. 1C, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. If the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

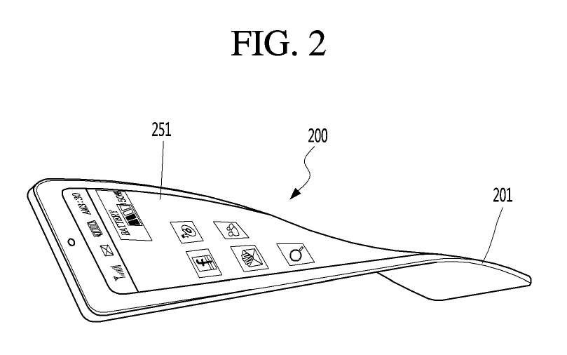

FIG. 2 is a conceptual view of a deformable mobile terminal according to an alternative embodiment of the present invention. In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In general, mobile terminal 200 may be configured to include features that are the same or similar to that of mobile terminal 100 of FIGS. 1A-1C.

The flexible display of mobile terminal 200 is generally formed as a lightweight, non-fragile display, which still exhibits characteristics of a conventional flat panel display, but is instead fabricated on a flexible substrate which can be deformed as noted previously. The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When the flexible display unit 251 is not deformed (for example, in a state with an infinite radius of curvature and referred to as a first state), a display region of the flexible display unit 251 includes a generally flat surface. If when the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized so a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, if an external force is applied to the flexible display unit 251, the flexible display unit 251 may transition to the second state such that the flexible display unit is deformed into the flat state (or a less curved state) or into a more curved state.

If desired, the flexible display unit 251 may implement a flexible touch screen using a touch sensor in combination with the display. If a touch is received at the flexible touch screen, the controller 180 can execute certain control corresponding to the touch input. In general, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140. The deformation sensor may be located in the flexible display unit 251 or the case 201 to sense information related to the deforming of the flexible display unit 251. Examples of such information related to the deforming of the flexible display unit 251 may be a deformed direction, a deformed degree, a deformed position, a deformed amount of time, an acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some embodiments, controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251.

A battery located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

In accordance with still further embodiments, a mobile terminal may be configured as a device which is wearable on a human body. Such devices go beyond the usual technique of a user grasping the mobile terminal using their hand. Examples of the wearable device include a smart watch, a smart glass, a head mounted display (HIVID), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, if the sensed wearable device is a device which is authenticated to communicate with the mobile terminal 100, the controller 180 can transmit data processed in the mobile terminal 100 to the wearable device via the short-range communication module 114, for example. Hence, a user of the wearable device can use the data processed in the mobile terminal 100 on the wearable device. For example, if a call is received in the mobile terminal 100, the user can answer the call using the wearable device. Also, if a message is received in the mobile terminal 100, the user can check the received message using the wearable device.

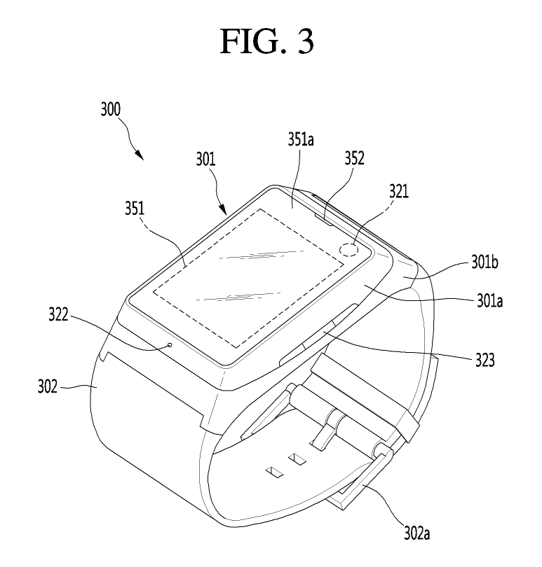

FIG. 3 is a perspective view illustrating one example of a watch-type mobile terminal 300 in accordance with another exemplary embodiment. As illustrated in FIG. 3, the watch-type mobile terminal 300 includes a main body 301 with a display unit 351 and a band 302 connected to the main body 301 to be wearable on a wrist. In general, mobile terminal 300 may be configured to include features that are the same or similar to that of mobile terminal 100 of FIGS. 1A-1C.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some embodiments, the display unit 351 includes a touch sensor so that the display unit can function as a touch screen. As illustrated, window 351a is positioned on the first case 301a to form a front surface of the terminal body together with the first case 301a.

The illustrated embodiment includes audio output module 352, a camera 321, a microphone 322, and a user input unit 323 positioned on the main body 301. If the display unit 351 is implemented as a touch screen, additional function keys may be minimized or eliminated. For example, if the touch screen is implemented, the user input unit 323 may be omitted.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In one configuration, the band 302 may be used for extending the performance of the antenna. For example, the band may include therein a ground extending portion electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

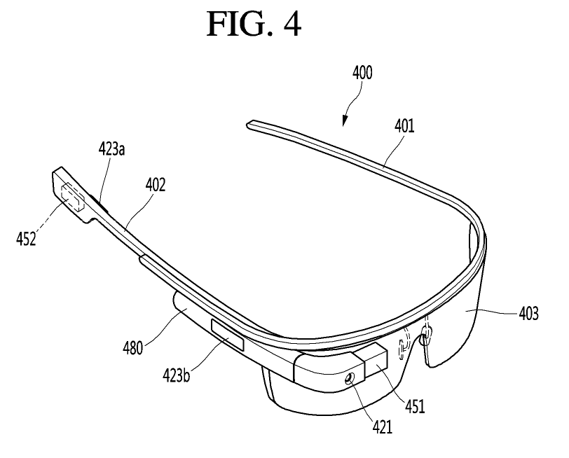

FIG. 4 is a perspective view illustrating one example of a glass-type mobile terminal 400 according to another exemplary embodiment. The glass-type mobile terminal 400 can be wearable on a head of a human body and provided with a frame (case, housing, etc.) therefor. The frame may be made of a flexible material to be easily worn. The frame of mobile terminal 400 is shown having a first frame 401 and a second frame 402, which can be made of the same or different materials. In general, mobile terminal 400 may be configured to include features that are the same or similar to that of mobile terminal 100 of FIGS. 1A-1C.

The frame may be supported on the head and defines a space for mounting various components. As illustrated, electronic components, such as a control module 480, an audio output module 452, and the like, may be mounted to the frame part. Also, a lens 403 for covering either or both of the left and right eyes may be detachably coupled to the frame part.

The control module 480 controls various electronic components disposed in the mobile terminal 400. The control module 480 may be understood as a component corresponding to the aforementioned controller 180. FIG. 4 illustrates that the control module 480 is installed in the frame part on one side of the head, but other locations are possible.

The display unit 451 may be implemented as a head mounted display (HIVID). The HIVID refers to display techniques by which a display is mounted to a head to show an image directly in front of a user's eyes. In order to provide an image directly in front of the user's eyes if the user wears the glass-type mobile terminal 400, the display unit 451 may be located to correspond to either or both of the left and right eyes. FIG. 4 illustrates that the display unit 451 is located on a portion corresponding to the right eye to output an image viewable by the user's right eye.

The display unit 451 may project an image into the user's eye using a prism. Also, the prism may be formed from optically transparent material such that the user can view both the projected image and a general visual field (a range that the user views through the eyes) in front of the user. In such a manner, the image output through the display unit 451 may be viewed while overlapping with the general visual field. The mobile terminal 400 may provide an augmented reality (AR) by overlaying a virtual image on a realistic image or background using the display.

The camera 421 may be located adjacent to either or both of the left and right eyes to capture an image. Since the camera 421 is located adjacent to the eye, the camera 421 can acquire a scene that the user is currently viewing. The camera 421 may be positioned at most any location of the mobile terminal. In some embodiments, multiple cameras 421 may be utilized. Such multiple cameras 421 may be used to acquire a stereoscopic image.

The glass-type mobile terminal 400 may include user input units 423a and 423b, which can each be manipulated by the user to provide an input. The user input units 423a and 423b may employ techniques which permit input via a tactile input. Typical tactile inputs include a touch, push, or the like. The user input units 423a and 423b are shown operable in a pushing manner and a touching manner as they are located on the frame part and the control module 480, respectively.

If desired, mobile terminal 400 may include a microphone which processes input sound into electric audio data, and an audio output module 452 for outputting audio. The audio output module 452 may be configured to produce audio in a general audio output manner or an osteoconductive manner. If the audio output module 452 is implemented in the osteoconductive manner, the audio output module 452 may be closely adhered to the head if the user wears the mobile terminal 400 and vibrate the user's skull to transfer sounds.

A communication system which is operable with the variously described mobile terminals will now be described in more detail. Such a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (UMTS) (including, Long Term Evolution (LTE), LTE-A (Long Term Evolution-Advanced)), Global System for Mobile Communications (GSM), and the like.

By way of a non-limiting example only, further description will relate to a CDMA communication system, but such teachings apply equally to other system types including a CDMA wireless communication system as well as OFDM (Orthogonal Frequency Division Multiplexing) wireless communication system. A CDMA wireless communication system generally includes one or more mobile terminals (MT or User Equipment, UE) 100, one or more base stations (BSs, NodeB, or evolved NodeB), one or more base station controllers (BSCs), and a mobile switching center (MSC). The MSC is configured to interface with a conventional Public Switched Telephone Network (PSTN) and the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs can be included in the CDMA wireless communication system.

Each base station may include one or more sectors, each sector having an omni-directional antenna or an antenna pointed in a particular direction radially away from the base station. Alternatively, each sector may include two or more different antennas. Each base station may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In some cases, the term “base station” may be used to refer collectively to a BSC, and one or more base stations. The base stations may also be denoted as “cell sites.” Alternatively, individual sectors of a given base station may be referred to as cell sites.

A broadcasting transmitter (BT) transmits a broadcast signal to the mobile terminals 100 operating within the system. The broadcast receiving module 111 of FIG. 1A is typically configured inside the mobile terminal 100 to receive broadcast signals transmitted by the BT.

Global Positioning System (GPS) satellites for locating the position of the mobile terminal 100, for example, may cooperate with the CDMA wireless communication system. Useful position information may be obtained with greater or fewer satellites than two satellites. It is to be appreciated that other types of position detection technology, (i.e., location technology that may be used in addition to or instead of GPS location technology) may alternatively be implemented. If desired, at least one of the GPS satellites may alternatively or additionally be configured to provide satellite DMB transmissions.

The location information module 115 is generally configured to detect, calculate, or otherwise identify a position of the mobile terminal. As an example, the location information module 115 may include a Global Position System (GPS) module, a Wi-Fi module, or both. If desired, the location information module 115 may alternatively or additionally function with any of the other modules of the wireless communication unit 110 to obtain data related to the position of the mobile terminal.

A typical GPS module 115 can measure an accurate time and distance from three or more satellites, and accurately calculate a current location of the mobile terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites.

Furthermore, the GPS module can acquire speed information in real time to calculate a current position. Sometimes, accuracy of a measured position may be compromised if the mobile terminal is located in a blind spot of satellite signals, such as being located in an indoor space. In order to minimize the effect of such blind spots, an alternative or supplemental location technique, such as Wi-Fi Positioning System (WPS), may be utilized.

The Wi-Fi positioning system (WPS) refers to a location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module. The Wi-Fi positioning system may include a Wi-Fi location determination server, a mobile terminal, a wireless access point (AP) connected to the mobile terminal, and a database stored with wireless AP information.

The mobile terminal connected to the wireless AP may transmit a location information request message to the Wi-Fi location determination server. The Wi-Fi location determination server extracts the information of the wireless AP connected to the mobile terminal 100, based on the location information request message (or signal) of the mobile terminal 100. The information of the wireless AP may be transmitted to the Wi-Fi location determination server through the mobile terminal 100, or may be transmitted to the Wi-Fi location determination server from the wireless AP.

The information of the wireless AP extracted based on the location information request message of the mobile terminal 100 may include one or more of media access control (MAC) address, service set identification (SSID), received signal strength indicator (RSSI), reference signal received Power(RSRP), reference signal received quality (RSRQ), channel information, privacy, network type, signal strength, noise strength, and the like.

The Wi-Fi location determination server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only a predetermined number of wireless AP information in order of high RSSI.

Then, the Wi-Fi location determination server may extract (analyze) location information of the mobile terminal 100 using at least one wireless AP information extracted from the database. A method for extracting (analyzing) location information of the mobile terminal 100 may include a Cell-ID method, a fingerprint method, a trigonometry method, a landmark method, and the like.

The Cell-ID method is used to determine a position of a wireless AP having the largest signal strength, among peripheral wireless AP information collected by a mobile terminal, as a position of the mobile terminal. The Cell-ID method is an implementation that is minimally complex, does not require additional costs, and location information can be rapidly acquired. However, in the Cell-ID method, the precision of positioning may fall below a desired threshold if the installation density of wireless APs is low.

The fingerprint method is used to collect signal strength information by selecting a reference position from a service area, and to track a position of a mobile terminal using the signal strength information transmitted from the mobile terminal based on the collected information. In order to use the fingerprint method, it is common for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless APs, signal strength may be converted into distance information, Time of Arrival (ToA), Time Difference of Arrival (TDoA), Angle of Arrival (AoA), or the like may be taken for transmitted wireless signals.

The landmark method is used to measure a position of a mobile terminal using a known landmark transmitter. In addition to these position location methods, various algorithms may be used to extract (analyze) location information of a mobile terminal. Such extracted location information may be transmitted to the mobile terminal 100 through the Wi-Fi location determination server, thereby acquiring location information of the mobile terminal 100.

The mobile terminal 100 can acquire location information by being connected to at least one wireless AP. The number of wireless APs required to acquire location information of the mobile terminal 100 may be variously changed according to a wireless communication environment within which the mobile terminal 100 is positioned.

As previously described with regard to FIG. 1A, the mobile terminal may be configured to include short-range communication techniques such as Bluetooth™, Radio Frequency Identification (RFID), Infrared Data Association (IrDA), UltraWideband (UWB), ZigBee, Near Field Communication (NFC), Wireless USB (Wireless Universal Serial Bus), and the like.

A typical NFC module provided at the mobile terminal supports short-range wireless communication, which is a non-contactable type of communication between mobile terminals and generally occurs within about 10 cm. The NFC module may operate in one of a card mode, a reader mode, or a P2P mode. The mobile terminal 100 may further include a security module for storing card information, in order to operate the NFC module in a card mode. The security module may be a physical medium such as Universal Integrated Circuit Card (UICC) (e.g., a Subscriber Identification Module (SIM) or Universal SIM (USIM)), a secure micro SD and a sticker, or a logical medium (e.g., embedded Secure Element (SE)) embedded in the mobile terminal. Single Wire Protocol (SWP)-based data exchange may be performed between the NFC module and the security module.

When the NFC module operates in a card mode, the mobile terminal may transmit card information on a general IC card to the outside. More specifically, if a mobile terminal having card information on a payment card (e. g, a credit card or a bus card) approaches a card reader, a short-range mobile payment may be executed. As another example, if a mobile terminal which stores card information on an entrance card approaches an entrance card reader, an entrance approval procedure may start. A card such as a credit card, a traffic card, or an entrance card may be included in the security module in the form of applet, and the security module may store card information on the card mounted therein. Card information for a payment card may include any of a card number, a remaining amount and usage history, and the like. Card information of an entrance card may include any of a user's name, a user's number (e.g., undergraduate number or staff number), an entrance history, and the like.

If the NFC module operates in a reader mode, the mobile terminal can read data from an external tag. The data received from the external tag by the mobile terminal may be coded into the NFC Data Exchange Format defined by the NFC Forum. The NFC Forum generally defines four record types. More specifically, the NFC Forum defines four Record Type Definitions (RTDs) such as smart poster, text, Uniform Resource Identifier (URI), and general control. If the data received from the external tag is a smart poster type, the controller may execute a browser (e.g., Internet browser). If the data received from the external tag is a text type, the controller may execute a text viewer. If the data received from the external tag is a URI type, the controller may execute a browser or originate a call. If the data received from the external tag is a general control type, the controller may execute a proper operation according to control content.

In some cases in which the NFC module operates in a P2P (Peer-to-Peer) mode, the mobile terminal can execute P2P communication with another mobile terminal. In this instance, Logical Link Control Protocol (LLCP) may be applied to the P2P communication. For P2P communication, connection may be generated between the mobile terminal and another mobile terminal. This connection may be categorized as a connectionless mode which ends after one packet is switched, and a connection-oriented mode in which packets are switched consecutively. For a typical P2P communication, data such as an electronic type name card, address information, a digital photo and a URL, a setup parameter for Bluetooth connection, Wi-Fi connection, etc. may be switched. The P2P mode can be effectively utilized in switching data of a small capacity, because an available distance for NFC communication is relatively short.

Further preferred embodiments will be described in more detail with reference to additional drawing figures. It is understood by those skilled in the art that the present features can be embodied in several forms without departing from the characteristics thereof.

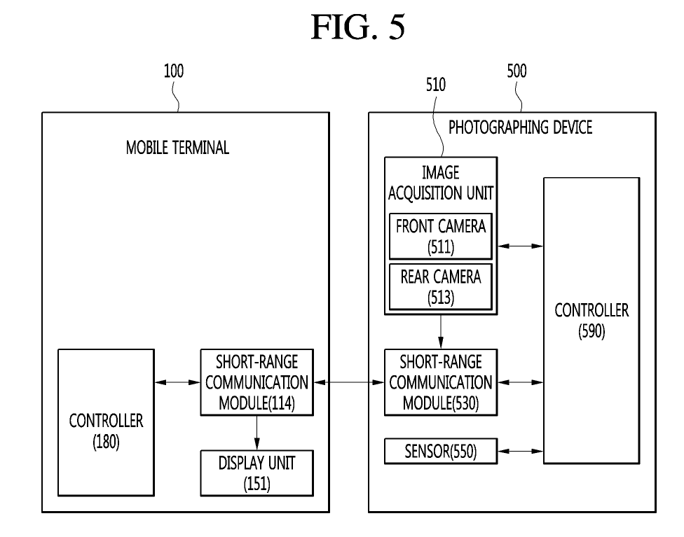

FIG. 5 is view illustrating a configuration of a mobile terminal and a photographing device according to an embodiment of the present invention. Only some of the components of the mobile terminal 100 shown in FIG. 1 are illustrated in FIG. 5. A description of the configuration of the mobile terminal 100 shown in FIG. 5 is replaced by that of FIG. 1.

An omnidirectional photographing device 500 includes an image acquisition unit 510, a short-range communication module 530, a sensor 550, and a controller 590. The image acquisition unit 510 can acquire an omnidirectional image by photographing an omnidirectional background around the omnidirectional photographing device 500. The omnidirectional image may have a spherical shape. The omnidirectional image can be referred to as a 360-degree image.

The image acquisition unit 510 may include a plurality of cameras. In FIG. 5, a front camera 511 and a rear camera 513 have been illustrated as an example, but the present invention is not limited thereto. That is, three or more cameras can be provided in the omnidirectional photographing device 500.

Each of the front camera 511 and the rear camera 513 can include a fisheye lens having an angle of view of 180 degrees or more. Each of the front camera 511 and the rear camera 513 can photograph an omnidirectional background through the fisheye lens.

The controller 590 can generate an omnidirectional image by synthesizing, in a spherical shape, two omnidirectional partial images acquired through the respective fisheye lenses. The short-range communication module 530 can wirelessly transmit, the mobile terminal 100, the spherical omnidirectional image generated by the controller 590. The short-range communication module 530 can transmit the omnidirectional image to the mobile terminal 100 using any one communication protocol among Wi-Fi Direct, Bluetooth, and Wi-Fi, but the communication protocol is merely an example.

The omnidirectional photographing device 500 can include a wired communication interface such as a USB interface as well as the short-range communication module. The omnidirectional photographing device 500 can perform communication with the mobile terminal 100 through the wired communication interface.

The sensor 550 can include at least one of a gyro sensor and an acceleration sensor. The controller 590 can control overall operations of the omnidirectional photographing device 500. In addition, the omnidirectional photographing device 500 can include at least one microphone.

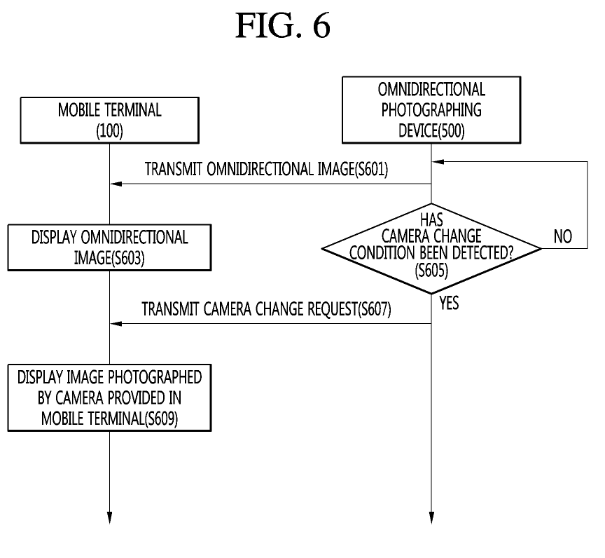

Next, FIG. 6 is a ladder diagram illustrating an operating method of a photographing system according to an embodiment of the present invention. The photographing system according to the embodiment of the present invention may include the mobile terminal 100 and the omnidirectional photographing device 500, which are shown in FIG. 5.

Referring to FIG. 6, the short-range communication module 114 of the mobile terminal 100 receives an omnidirectional image from the short-range communication module 530 of the omnidirectional photographing device 500 (S601). It is assumed that the mobile terminal 100 and the omnidirectional photographing device 500 are paired with each other. The mobile terminal 100 and the omnidirectional photographing device 500 are connected to each other in the pairing state, to exchange information.

In an embodiment, the short-range communication modules 114 and 530 may use a Bluetooth communication protocol. However, this is merely an example, and the short-range communication modules 114 and 530 can use various short-range communication protocols. The mobile terminal 100 can receive, in real time, an omnidirectional image from the omnidirectional photographing device 500 as a camera application installed in the mobile terminal 100 is executed.

The omnidirectional image is an image obtained as the omnidirectional photographing device 500 photographs an omnidirectional photographing background in which the omnidirectional photographing device 500 is located. The display unit 151 of the mobile terminal 100 displays the omnidirectional image received from the omnidirectional photographing device 500 (S603).

In an embodiment, the short-range communication module 114 of the mobile terminal 100 can receive, in real time, an omnidirectional image photographed by the omnidirectional photographing device 500. The display unit 151 can then display the omnidirectional image received in real time on a preview screen.

Further, the display unit 151 can display only a partial image of the received omnidirectional image. The partial image displayed by the display unit 151 can be an image photographed through any one of the front camera 511 or the rear camera 513 of the omnidirectional photographing device 500.

In addition, the controller 590 of the omnidirectional photographing device 500 checks whether a camera change condition has been detected (S605). The camera change condition may be changing photographing of a subject from the omnidirectional photographing device 500 to the mobile terminal 100. Specifically, the camera change condition may be changing a main agent of photographing the subject from the image acquisition unit of the omnidirectional photographing device 500 to the camera 121 provided in the mobile terminal 100.

The controller 590 of the omnidirectional photographing device 500 can detect the camera change condition, based on a distance between a subject as an object to be photographed and the omnidirectional photographing device 500. Specifically, if the distance between the subject and the omnidirectional photographing device 500 is less than a reference distance, the controller 590 can determine that the camera change condition has been detected. If the distance between the subject and the omnidirectional photographing device 500 is equal to or greater than the reference distance, the controller 590 can determine that the camera change condition has not been detected. The reference distance may be 10 cm, but this is merely an example.

The sensor 550 provided in the omnidirectional photographing device 500 can include any one of a distance sensor and an infrared sensor. Any one of the distance sensor and the infrared sensor can measure a distance between the subject and the omnidirectional photographing device 500. The controller 590 can detect the camera change condition, based on the measured distance.

If the camera change condition is detected, the controller 590 of the omnidirectional photographing device 500 transmits a camera change request to the mobile terminal (S607). The camera change request may be a request for turning on power of the camera 121 provided in the mobile terminal 100. Specifically, the camera change request may be a request for turning on the power of the camera 121 provided in the mobile terminal, to display an image photographed by the camera 121 on a preview screen of the mobile terminal 100.

The controller 590 of the omnidirectional photographing device 500 can turn off power of the image acquisition unit 510 in response to the camera change request. Specifically, the controller 590 may not supply power to the front camera 511 and the rear camera 513, which are provided in the image acquisition unit 510. Accordingly, the omnidirectional photographing device 500 can stop the photographing of the omnidirectional image.

The controller 180 of the mobile terminal 100 displays the image photographed by the camera 121 provided in the mobile terminal 100 through the display unit 151, in response to the camera change request received through the omnidirectional photographing device 500 (S609). The controller 180 of the mobile terminal 100 can turn on the power of the camera 121 provided in the mobile terminal 100, in response to the camera change request received from the omnidirectional photographing device 500. The controller 180 can display an image of a subject photographed through the camera 121 of which power is turned on, on the preview screen of the display unit 151.

As a result, the omnidirectionally photographed image can be photographed at a fixed angle of view. The controller 180 of the mobile terminal 100 can receive the camera change request through the short-range communication module 114. After the camera change request is received, the controller 180 can stop a connection with the omnidirectional photographing device 500. That is, the controller 180 can stop a connection between the short-range communication module 114 and the short-range communication module 530 of the omnidirectional photographing device 500.

According to another embodiment of the present invention, the controller 180 of the mobile terminal 100 can detect the camera change condition. In this instance, step S605 can be performed by the controller 180 of the mobile terminal 100, and step S607 may be omitted.

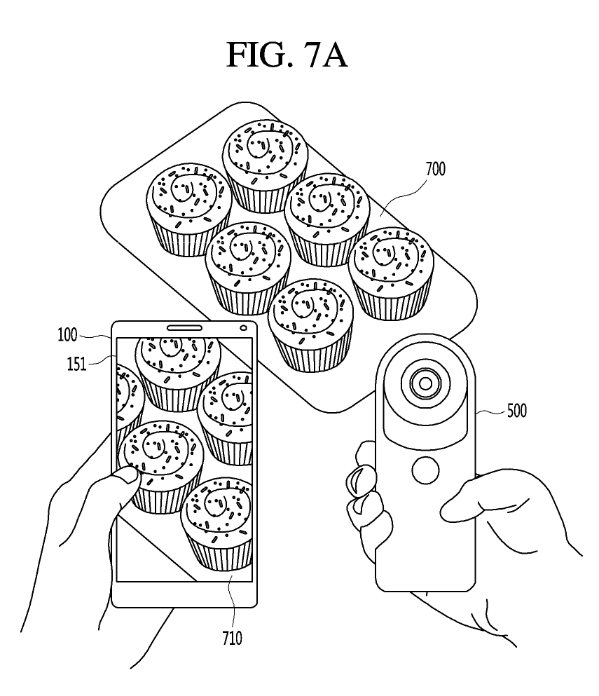

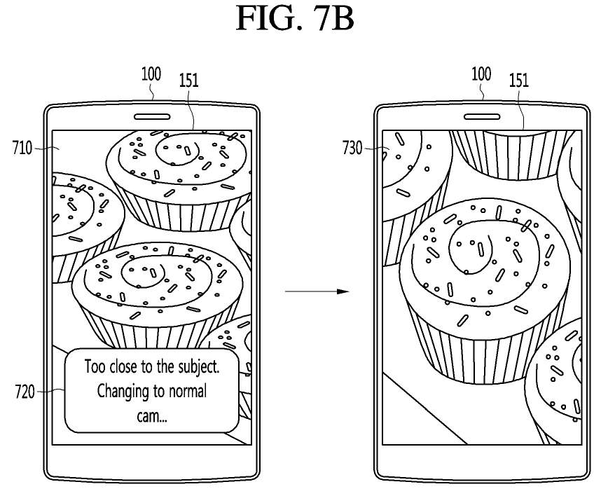

The embodiment of FIG. 6 will be described with reference to the accompanying drawings. In particular, FIGS. 7A and 7B are views illustrating an example in which, if a camera change condition is detected, a main agent of photographing a subject is changed from the photographing device to the mobile terminal according to an embodiment of the present invention.

Referring to FIG. 7A, the omnidirectional photographing device 500 is photographing a subject 700. The omnidirectional photographing device 500 can transmit an omnidirectional image including the subject 700 to the mobile terminal 100. The display unit 151 of the mobile terminal 100 can display a partial image 710 of the omnidirectional image transmitted from the omnidirectional photographing device 500.

In this state, if a distance between the omnidirectional photographing device 500 and the subject 700 is less than the reference distance, the controller 590 of the omnidirectional photographing device 500 can determine that the camera change condition has been detected. If the camera change condition is detected, the controller 590 of the omnidirectional photographing device 500 can transmit a camera change request to the mobile terminal 100.

The controller 180 of the mobile terminal 100, as shown in FIG. 7B, can display a popup window 720 representing that, since the omnidirectional photographing device 500 is too close to the subject, the main agent of photographing the subject has been changed from the camera of the omnidirectional photographing device 500 to the camera of the mobile terminal 100, in response to the camera change request received from the omnidirectional photographing device 500.

After that, the controller 180 of the mobile terminal 100 can turn on the power of the camera 121 provided in the mobile terminal 100 and display an image 730 of the subject photographed through the camera 121 through the display unit 151. The image 730 of the subject 700 may be an image having a fixed angle of view.

Also, the controller 180 can execute a camera application installed in the mobile terminal 100 in response to the camera change request received from the omnidirectional photographing device 500. Accordingly, the controller 180 of the mobile terminal 100 can display the image 730 of the subject on a preview screen. That is, the image 730 of the subject can become a preview image.

Meanwhile, the camera change condition can also be detected through the mobile terminal 100 instead of the omnidirectional photographing device 500. That is, the controller 180 can receive information on the distance between the omnidirectional photographing device 500 and the subject from the omnidirectional photographing device 500.

If the distance between the omnidirectional photographing device 500 and the subject is less than the reference distance, the controller 180 can determine that the camera change condition has been detected. If the mobile terminal 100 detects the camera change condition, the controller 180 can automatically display the image 730 of the subject photographed by the camera 121 on the preview screen.

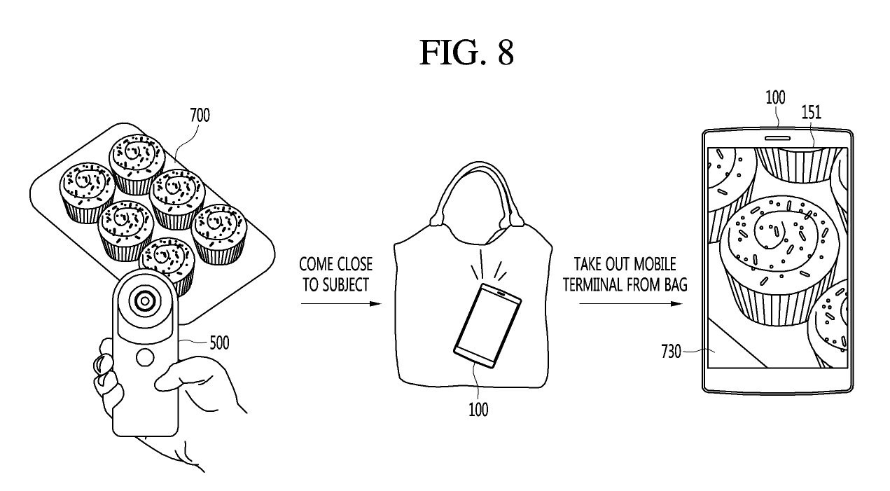

Next, FIG. 8 is a view illustrating an example in which, if the camera change condition is detected, a main agent of photographing a subject is changed from the photographing device to the mobile terminal according to another embodiment of the present invention.

In particular, FIG. 8 is different from FIGS. 7A and 7B in that a user does not hold the mobile terminal 100 but is holding only the omnidirectional photographing device 500. The omnidirectional photographing device 500 photographs an image of an omnidirectional background including the subject 700. If a distance between the omnidirectional photographing device 500 and the subject 700 is less than the reference distance, the controller 590 of the omnidirectional photographing device 500 can determine that the camera change condition has been detected.

If the camera change condition is detected, the controller 590 can transmit a camera change request to the mobile terminal 100 pairing therewith. The camera change request may include a notification that allows a main agent of photographing the subject to be changed from the omnidirectional photographing device 500 to the mobile terminal 100.

The controller 180 of the mobile terminal 100 can generate a vibration representing the camera change request through the haptic module 153 or output a voice representing the camera change request through the audio output module 152, based on the camera change request received from the omnidirectional photographing device 500. For example, if the mobile terminal 100 is placed in a bag, the controller 180 can generate a vibration or output a voice, based on the camera change request. The user can take out the mobile terminal 100 from the bag through such a notification.

The controller 180 of the mobile terminal 100 can turn on the power of the camera 121 and display the image 730 of the subject photographed by the camera 121 through the display unit 151, in response to the camera change request. In the omnidirectional photographing device 500 that photographs an omnidirectional image, distortion of the photographed omnidirectional image may be deteriorated as the omnidirectional photographing device 500 comes close to the subject. In order to overcome this, the subject is photographed through the camera 121 of the mobile terminal 100, which is more suitable for proximity photographing, so that an optimally photographed image can be acquired.

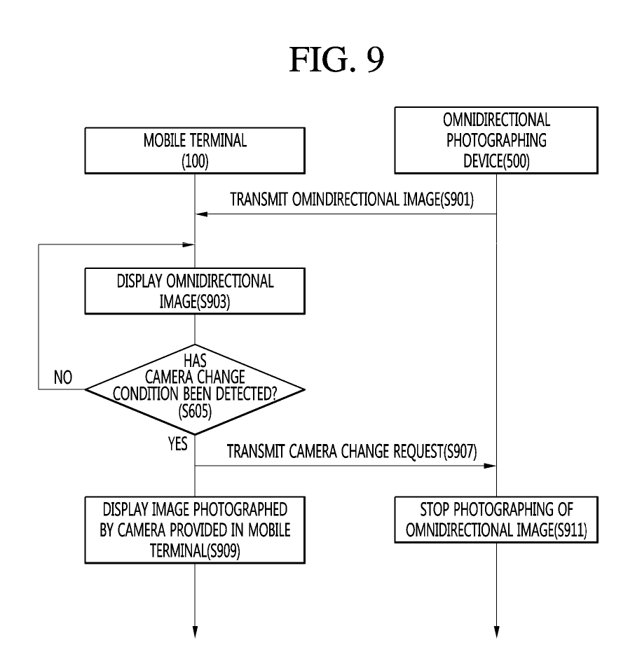

Next, FIG. 9 is a ladder diagram illustrating an operating method of the photographing system according to another embodiment of the present invention. An example in which, if the mobile terminal 100 detects a camera change condition, a camera change is automatically performed, will be described in FIG. 9. In comparison to FIG. 6, detailed descriptions of overlapping steps are replaced by those of FIG. 6.

Referring to FIG. 9, the short-range communication module 114 of the mobile terminal 100 receives an omnidirectional image from the short-range communication module 530 of the omnidirectional photographing device 500 (S901). The display unit 151 of the mobile terminal 100 displays the omnidirectional image received from the omnidirectional photographing device 500 (S903).

The controller 180 of the mobile terminal 100 checks whether the camera change condition has been detected (S905). The controller 180 can detect the camera change condition, based on the omnidirectional image being displayed through the display unit 151. Specifically, if the omnidirectional image being displayed through the display unit 151 is a body except a face of the user holding the omnidirectional photographing device 500, it may be determined that the camera change condition has been detected.

This may be a case where at least one of the front camera 511 and the rear camera 513 of the omnidirectional photographing device 500 is covered by an object. That is, this is when the front camera 511 or the rear camera 513 is covered by the body of the user due to a motion of an arm of the user holding the omnidirectional photographing device 500.

As another example, if the omnidirectional image being displayed through the display unit 151 includes an image of the mobile terminal 100 that is displaying the omnidirectional image, the controller 180 can determine that the camera change condition has been detected. This may be when the front camera 511 of the omnidirectional photographing device 500 is covered by the mobile terminal 100.

In another embodiment, the controller 180 can detect the camera change condition, based on a distance between an object received from the omnidirectional photographing device 500 and the omnidirectional photographing device 500. The controller 180 can receive the distance between the object and the omnidirectional photographing device 500 through the short-range communication module 114. If the received distance is less than a reference distance, the controller 180 can determine that the camera change condition has been detected.

In another embodiment, if a distance between the front camera 511 of the omnidirectional photographing device 500 and the mobile terminal 100 is within a predetermined distance, the controller 180 can determine that the camera change condition has been detected. Here, the predetermined distance may be 1 cm, but this is merely an example.

If the camera change condition is detected, the controller 180 transmits a camera change request to the omnidirectional photographing device 500 (S907) and displays an image photographed by the camera 121 provided in the mobile terminal 100 through the display unit 151 (S909).

The camera change request that the controller 180 transmits to the omnidirectional photographing device 500 can be a request for stopping photographing of the omnidirectional image. Specifically, the camera change request may be a request for turning off power of the front camera 511 and the rear camera 513 of the omnidirectional photographing device 500. In another embodiment, the camera change request that the controller 180 transmits to the omnidirectional photographing device 500 can be a request for stopping a connection between the omnidirectional photographing device 500 and the mobile terminal 100.

After the camera change request is transmitted to the omnidirectional photographing device 500, the controller 180 can turn on power of the camera 121 provided in the mobile terminal 100. Accordingly, the controller 180 can display an image of a subject photographed by the camera 121 through the display unit 151. The image of the subject may be an image photographed through one camera 121 having a fixed angle of view.

In addition, the omnidirectional photographing device 500 stops the photographing of the omnidirectional image in response to the camera change request received from the mobile terminal 100 (S911). That is, the omnidirectional photographing device 500 can turn off the power of the front camera 511 and the rear camera 513.

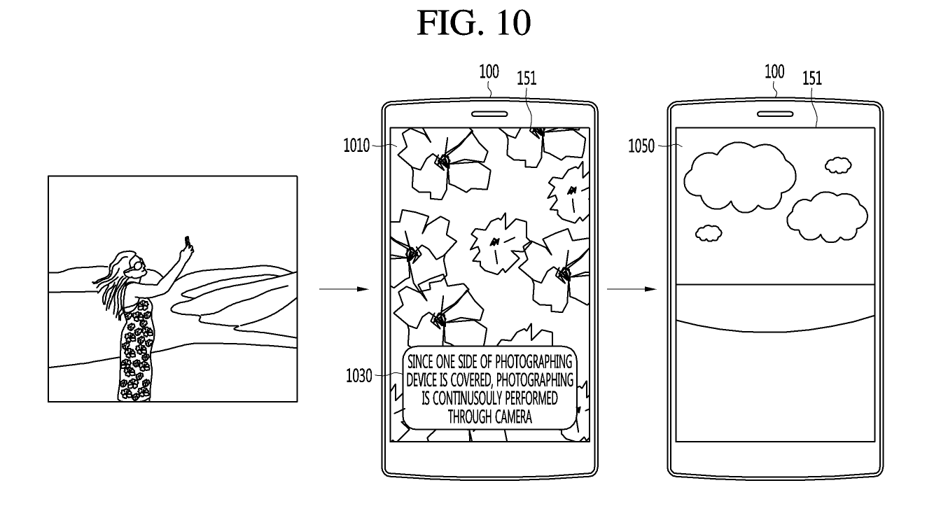

The embodiment of FIG. 9 will be described with reference to the accompanying drawings. In particular, FIG. 10 is a view illustrating an example in which, if a camera change condition is detected, a main agent of photographing a subject is changed from the photographing device to the mobile terminal according to another embodiment of the present invention.

Referring to FIG. 10, the user is photographing an omnidirectional background while holding the omnidirectional photographing device 500. The mobile terminal 100 can display, in real time, a partial image 1010 of an omnidirectional image received from the omnidirectional photographing device 500. If the partial image of the omnidirectional image displayed through the display unit 151 is a body except a face of the user, the controller 180 of the mobile terminal 100 can determine that the camera change condition has been detected.

The controller 180 of the mobile terminal 100, as shown in FIG. 10, can display a popup window 1030 representing the change condition had been detected, in accordance with the camera change request transmitted from the omnidirectional photographing device 500.

The controller 180 can transmit a camera change request to the omnidirectional photographing device 500 and then display an image 1050 photographed by the camera 121 provided in the mobile terminal 100 on the display unit 151. That is, the omnidirectional background or the main agent of photographing the subject can be changed from the omnidirectional photographing device 500 to the mobile terminal 100.

If the omnidirectional photographing device 500 photographs a body of the user, the photographing may be meaningless due to an unintended motion of an arm of the user while the subject is being photographed by the omnidirectional photographing device 500. In order to overcome this, if at least one of the front camera 511 or the rear camera 513 of the omnidirectional photographing device 500 is covered by the body of the user, the mobile terminal 100 can continuously photograph the subject through the camera 121 provided in the mobile terminal 100. That is, although the user is placed in an unintended situation, an image of the subject can be photographed without any pause.

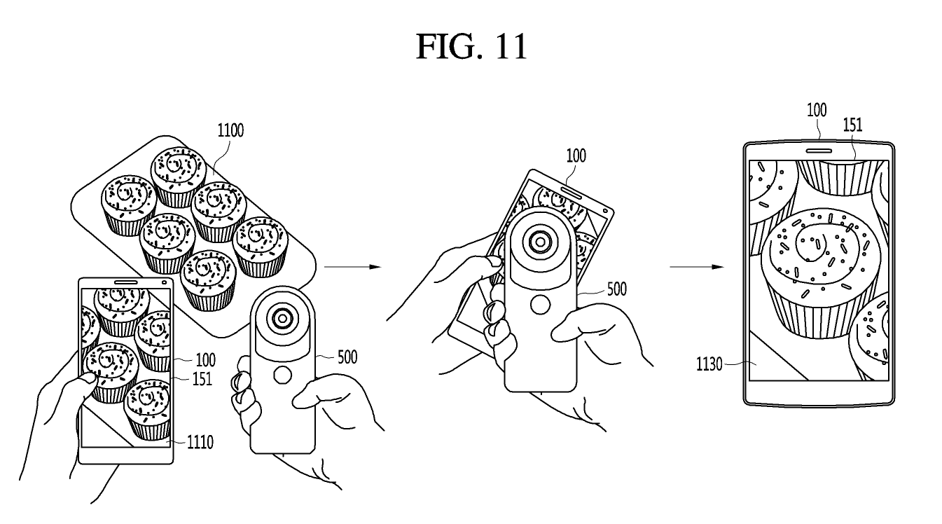

FIG. 11 is a view illustrating an example in which, if a camera change condition is detected, a main subject of photographing a subject is changed from the photographing device to the mobile terminal according to another embodiment of the present invention. Referring to FIG. 11, the omnidirectional photographing device 500 is photographing a subject 1100. The omnidirectional photographing device 500 can transmit, to the mobile terminal 100, an omnidirectional image corresponding to an omnidirectional background including the subject 1100.

The display unit 151 of the mobile terminal 100 can display a partial image 1110 of the omnidirectional image transmitted from the omnidirectional photographing device 500. In this state, the controller 180 of the mobile terminal 100 can check whether the camera change condition has been detected based on the partial image 1110 displayed on the display unit 151. Specifically, if an image of the mobile terminal 100 is included in the partial image of the omnidirectional image displayed on a preview screen, the controller 180 can determine that the camera change condition has been detected.

If the camera change condition is detected, the controller 180 can transmit a camera change request to the omnidirectional photographing device 500 and then automatically turn on the power of the camera 121 provided in the mobile terminal 100. Accordingly, the controller 180 can display an image 1130 of the subject 1100 photographed by the camera 121 through the display unit 151. That is, if the camera change condition is sensed, the mobile terminal 100 can automatically change a main agent of photographing the subject 1100 from the photographing device 500 to the mobile terminal 100.

If the camera change condition is detected, the omnidirectional photographing device 500 can stop photographing in response to the camera change request received from the mobile terminal 100. In addition, a connection between the mobile terminal 100 and the omnidirectional photographing device 500 can be stopped in response to the camera change request. According to another embodiment of the present invention, if the camera change condition is detected, the main agent of photographing the subject can be changed from the mobile terminal to the photographing device.

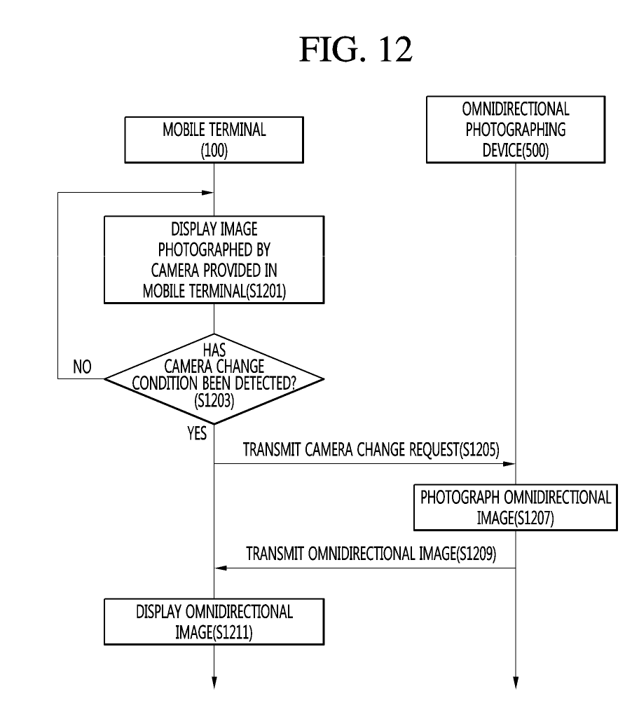

Next, FIG. 12 is a ladder diagram illustrating an operating method of the photographing system according to another embodiment of the present invention. Particularly, FIG. 12 is a ladder diagram illustrating an example in which, if a camera change condition is detected, a main agent of photographing a subject is changed from the mobile terminal to the photographing device.

Referring to FIG. 12, the display unit 151 of the mobile terminal 100 displays an image of a subject photographed by the camera 121 provided in the mobile terminal 100 (S1201). The camera 121 may be the rear camera 121b shown in FIG. 1C. The controller 180 checks whether the camera change condition has been detected (S1203).

The camera change condition may be a condition for changing a main agent of photographing the subject from the mobile terminal 100 to the omnidirectional photographing device 500. Specifically, the camera change condition may be a condition for changing the main agent of photographing the subject from the rear camera 121b of the mobile terminal 100 to the image acquisition unit 510 of the omnidirectional photographing device 500.

The controller 180 can check whether the camera change condition has been detected based on a touch input that is input on the display unit 151 displaying the image of the subject. As an example, if an icon for a camera change on the display unit 151 is selected, the controller 180 can determine that the camera change condition has been detected.

As another example, if a zoom-out command is received, the controller 180 can determine that the camera change condition has been detected. The zoom-out command may be received through a pinch-out input. This will be described later.

If the camera change condition is detected, the controller 180 transmits a camera change request to the omnidirectional photographing device 500 through the short-range communication module 114 (S1205). Here, the camera change request may be a request for turning on the power of the image acquisition unit 510 of the omnidirectional photographing device 500. As another example, the camera change request may be a request for starting pairing with the omnidirectional photographing device 500 and turning on the power of the image acquisition unit 510 of the omnidirectional photographing device 500.

The controller 590 of the omnidirectional photographing device 500 photographs an omnidirectional image through the image acquisition unit 510 in response to the receive camera change request (S1207) and transmits the photographed omnidirectional image to the mobile terminal (S1209). The controller 590 can turn on the power of the front camera 511 and the rear camera 513, which are included in the image acquisition unit 510, in response to the camera change request received from the mobile terminal 100.

Accordingly, the controller 590 can photograph the omnidirectional image through the front camera 511 and the rear camera 513, of which power is turned on. The photographed omnidirectional image can be transmitted in real time to the mobile terminal 100. The controller 180 of the mobile terminal 100 displays the omnidirectional image received from the omnidirectional photographing device 500 through the display unit 151 (S1211).

That is, the controller 180 can change an image that is currently photographed through the rear camera 121b to an omnidirectional image received through the omnidirectional photographing device 500 and display the omnidirectional image. The embodiment of FIG. 12 will be described in detail with reference to the accompanying drawings.

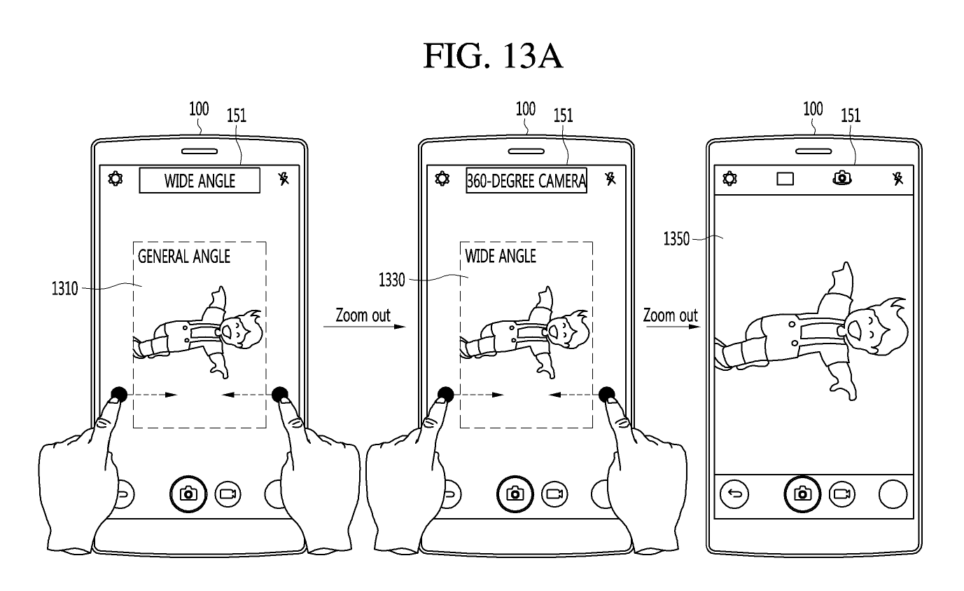

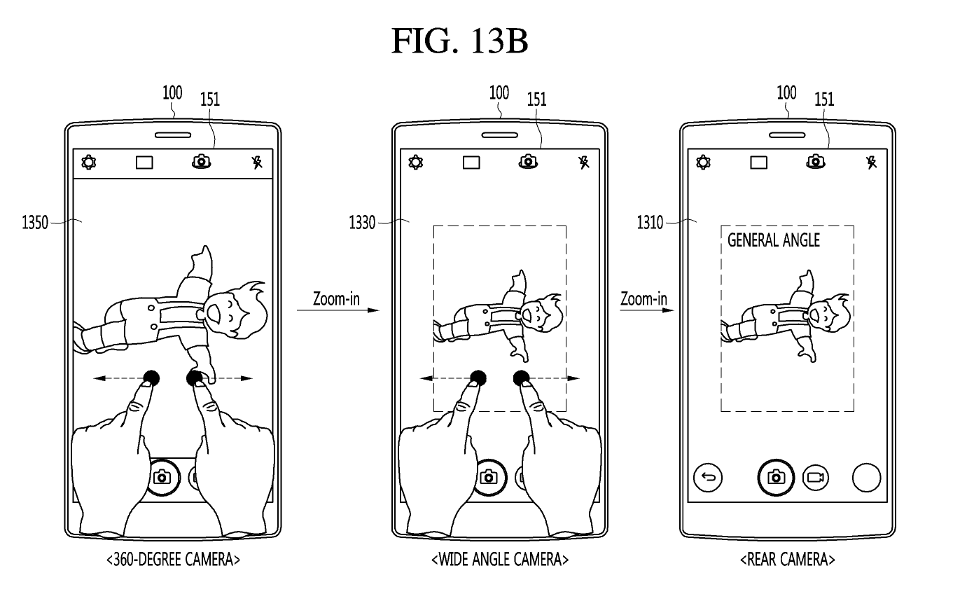

In particular, FIGS. 13A to 16 are views illustrating examples in which, if a camera change condition is detected, a main agent of photographing a subject is changed from the mobile terminal to the photographing device according to various embodiments of the present invention. In FIGS. 13A to 16, it is assumed that a subject is being photographed through the camera 121 provided in the mobile terminal 100. The camera 121 may be the rear camera 121b shown in FIG. 1C.

In FIG. 13A, it is assumed that the mobile terminal 100 includes the front camera 121a and the rear camera 121b, which are shown in FIG. 1C, and a wide angle camera. The rear camera 121b may be a camera having a first angle of view, and the wide angle camera may be a camera having a second angle of view. The wide angle camera may be disposed at a rear surface of the mobile terminal 100. The second angle of view may be greater than the first angle of view. The second angle of view may be 135 degrees, but this is merely an example. The wide angle camera can photograph up to a place that a person's view does not reach.

Referring to FIG. 13A, the display unit 151 of the mobile terminal 100 displays an image 1310 of a subject photographed by the rear camera 121b. That is, the image 1310 of the subject may be a preview image such as an image photographed through the rear camera 121b having the first angle of view.

In this state, if a zoom-out command is received, the controller 180 can change a main agent of photographing the subject from the rear camera 121b having the first angle of view to the wide angle camera having the second angle of view as shown in image 1330. The zoom-out command may be a pinch-in input. The pinch-in input may be an input obtained as two touch inputs on the display unit 151 move from the outside to the inside.

In this state, if the zoom-out command is again received, the controller 180 can determine that the camera change condition has been detected. If the camera change condition is detected, the controller 180 can change the main agent of photographing the subject from the wide angle camera to the image acquisition unit 510 of the omnidirectional photographing device 500.

As the camera change condition is detected, the controller 180 can transmit a camera change request to the omnidirectional photographing device 500. The controller 590 of the omnidirectional photographing device 500 receiving the camera change request may turn on the power of the image acquisition unit 510 and photograph an omnidirectional image of the subject. In addition, the omnidirectional photographing device 500 can transmit the photographed omnidirectional image to the mobile terminal 100.

The mobile terminal 100 can display a partial image 1350 of the omnidirectional image received from the omnidirectional photographing device 500 on the display unit 151. That is, the controller 180 of the mobile terminal 100 can change an image photographed by the wide angle camera to the omnidirectional image received from the omnidirectional photographing device 500.

The zoom-out command may be a command that reflects an intention of a user who intends to photograph a subject through a camera having a greater angle of view. The mobile terminal 100 can rapidly change the main agent of photographing the subject through the omnidirectional photographing device 500 having the greatest angle of view by detecting the intention of the user.

According to another embodiment of the present invention, the controller 180 can change the main agent of photographing the subject from the rear camera 121b to the omnidirectional photographing device 500 in response to one zoom-out command. If a zoom-in command is received in the state in which the partial image 1350 photographed by the omnidirectional photographing device 500 is displayed, the controller 180 can determine that the camera change condition has been satisfied.

Referring to FIG. 13B, the display unit 151 of the mobile terminal 100 is displaying the partial image 1350 of the omnidirectional image photographed by the omnidirectional photographing device 500. In this state, if a zoom-in command is received, the controller 180 can determine that the camera change condition has been detected. The controller 180 can change the main agent of photographing the subject from the omnidirectional photographing device 500 to the wide angle camera having the second angle of view as shown in image 1330. The zoom-in command may be a pinch-out command. The pinch-out command may be an input obtained as two touch inputs on the display unit 151 moves from the inside to the outside.

In this state, if the zoom-in command is again received, the controller 180 can determine that the camera change condition has been detected. If the camera change condition is received, the controller 180 can change the main agent of photographing the subject from the wide angle camera to the rear camera 121b having the first angle of view.

As the camera change condition is detected, the controller 180 can transmit a camera change request to the omnidirectional photographing device 500. The controller 590 of the omnidirectional photographing device 500 receiving the camera change request may turn off the power of the image acquisition unit 510 and stop the photographing of the omnidirectional image of the subject.

The mobile terminal 100 can display the image 1310 of the subject photographed by the rear camera 121b on the display unit 151. The zoom-in command may be a command that reflects an intention of the user who intends to photograph a subject through a camera having a smaller angle of view. The mobile terminal 100 can rapidly change the main agent of photographing the subject through the rear camera 121b having the smallest angle of view by detecting the intention of the user.

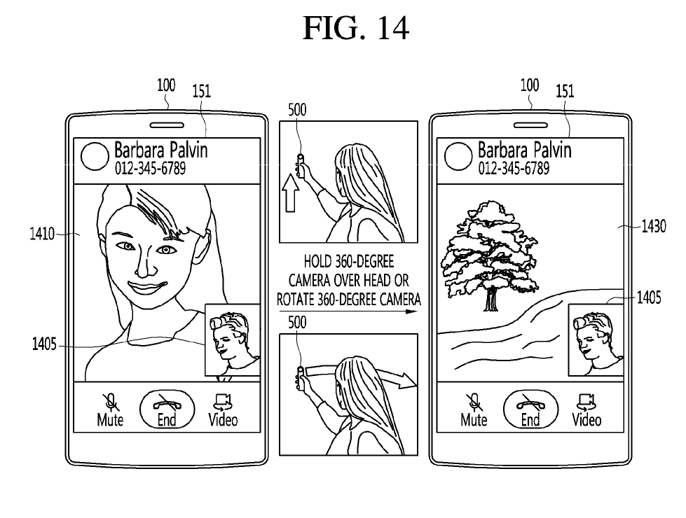

Next, FIG. 14 will be described. In FIG. 14, it is assumed that the user is performing a video call with an opponent terminal through the mobile terminal and is holding the omnidirectional photographing device 500. Referring to FIG. 14, the display unit 151 of the mobile terminal 100 is displaying a video call image 1410. The video call image 1410 may be an image being photographed through the front camera 121a or the rear camera 121b of the mobile terminal 100. The display unit 151 may further display an image 1405 of counterpart.

In this state, if a height of the omnidirectional photographing device 500 is higher than that of the mobile terminal 100, based on the ground, the controller 180 can determine that the camera change condition has been detected. Any one of a gyro sensor, an acceleration sensor, and a height sensor, which are provided in the mobile terminal 100, can measure a first distance at which the mobile terminal 100 is distant from the ground. In addition, the mobile terminal 100 can receive, from the omnidirectional photographing device 500, a second distance at which the omnidirectional photographing device 500 is distant from the ground. In order to measure the second distance, the omnidirectional photographing device 500 can also include any one of a gyro sensor, an acceleration sensor, and a height sensor.

If the first distance is greater than the second distance by comparing the first distance and the second distance, the controller 180 can determine that the camera change condition has been detected. That is, the omnidirectional photographing device 500 can be located at a higher place than the mobile terminal 100 while the user is performing the video call through the mobile terminal 100. This may be an intention of the user who intends to provide the opponent with an omnidirectional image of an omnidirectional background.

In addition, if the omnidirectional photographing device 500 is moved by a predetermined distance, the controller 180 can determine that the camera change condition has been detected. The controller 180 can receive, from the omnidirectional photographing device 500, information on a movement distance of the omnidirectional photographing device 500 while the video call is being performed. The omnidirectional photographing device 500 can measure information on a rotation distance or movement distance of the omnidirectional photographing device 500, using any one of the gyro sensor and the acceleration sensor, which are provided therein. The omnidirectional photographing device 500 can transmit the measured information to the mobile terminal 100.

If the omnidirectional photographing device 500 is moved by the predetermined distance or more, the controller 180 can determine, based on the receive information, that the camera change condition has been detected. During the performance of the video call, the user may rotate the omnidirectional photographing device 500 while holding the omnidirectional photographing device 500. This may be an intention of the user who intends to provide the opponent with an omnidirectional image of an omnidirectional background.

If the camera change condition is detected, the controller 180 can transmit a camera change request to the omnidirectional photographing device 500. Accordingly, the omnidirectional photographing device 500 can transmit the omnidirectional image of the omnidirectional background to the mobile terminal 100. The controller 180 of the mobile terminal 100 can change the video call image 1410 to a partial image 1430 of the received omnidirectional image. Simultaneously, the controller 180 of the mobile terminal 100 can transmit the omnidirectional image received from the omnidirectional photographing device 500 to the opponent terminal. Thus, the user can share, with the opponent, the omnidirectional background on which the user is located, during the performance of the video call.

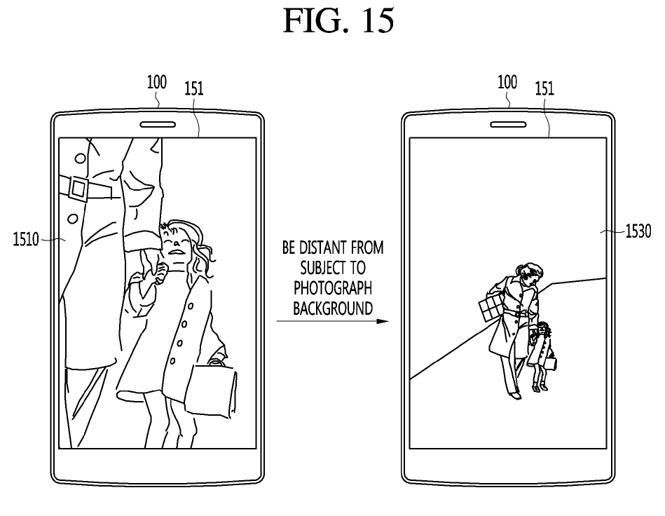

Next, FIG. 15 will be described. Referring to FIG. 15, the display unit 151 of the mobile terminal 100 is displaying an image 1510 of a subject being photographed through the rear camera 121b. In this state, the mobile terminal 100 can be distant from the subject to photograph a background. If the distance between the mobile terminal 100 and the subject is equal to or greater than a reference distance, the controller 180 can determine that the camera change condition has been detected.

As another example, the controller 180 can detect the camera change condition, based on a picture of the photographed subject. For example, if the size of a subject included in consecutively photographed pictures is gradually decreased if the subject is consecutively photographed, the controller 180 can determine that the camera change condition has been detected.

Specifically, if the size of a face of a person is equal to or smaller than a predetermined size as the size of the face of the person included in the photographed pictures is gradually decreased, the controller 180 can determine that the camera change condition has been detected.

If the camera change condition is detected, the controller 180 can transmit a camera change request to the omnidirectional photographing device 500. The omnidirectional photographing device 500 can turn on the power of the image acquisition unit 510 in response to the camera change request and photograph an omnidirectional background.

The omnidirectional photographing device 500 can transmit, to the mobile terminal 100, an omnidirectional image corresponding to the photographed omnidirectional background. The mobile terminal 100 can change the image 1510 of the subject being displayed on the display unit 151 to an omnidirectional image 1530 received from the omnidirectional photographing device 500.

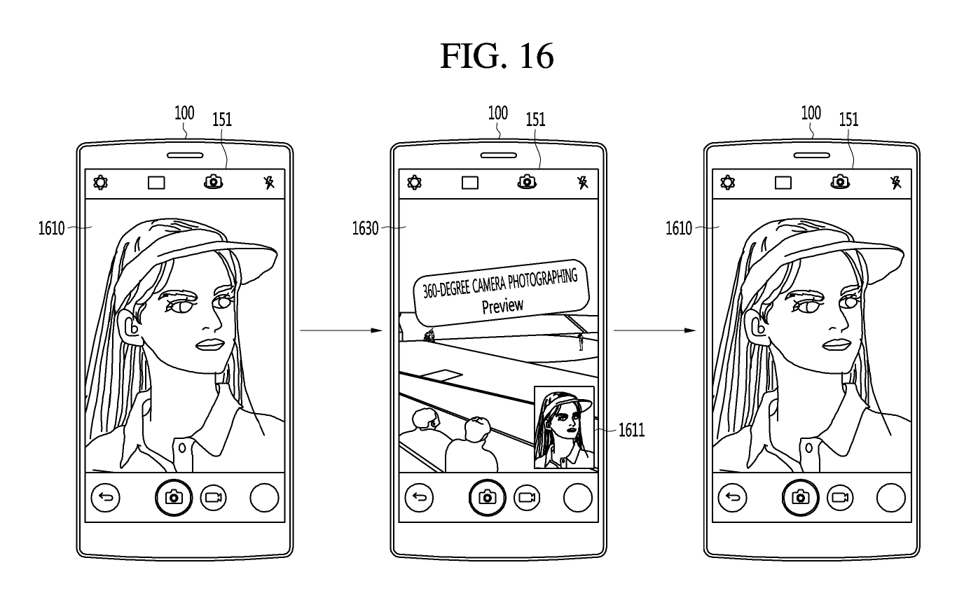

Next, FIG. 16 will be described. In FIG. 16, it is assumed that the user is photographing himself/herself through the front camera 121a of the mobile terminal 100 and is photographing an omnidirectional background through the omnidirectional photographing device 500.

Referring to FIG. 16, the display unit 151 of the mobile terminal 100 can display an image 1610 of the user being photographed through the front camera 121a. The image being photographed through the front camera 121a may be a moving picture. If a voice having a predetermined intensity or more, which is generated at the opposite side to a place at which the user is located during photographing is input, the controller 180 of the mobile terminal 100 can determine that the camera change condition has been detected. For example, the user may be placed in a baseball stadium and be photographing himself/herself through the front camera 121a of the mobile terminal 100 to broadcast a baseball game. In this state, as a baseball player hit a home run, noise of peripheral spectators may be loudly generated.

If the intensity of a peripheral voice input to the microphone 122 is equal to or greater than a predetermined intensity, the controller 180 can determine that the camera change condition has been detected. If the camera change condition is detected, the controller 180 can transmit a camera change request to the omnidirectional photographing device 500.

The omnidirectional photographing device 500 can transmit, to the mobile terminal 100, an omnidirectional image corresponding to the omnidirectional background in response to the received camera change request. The mobile terminal 100 can change the image 1610 of the user being displayed on the display unit 151 to a partial image 1630 of the omnidirectional image received from the omnidirectional photographing device 500. As another example, the controller 180, as shown in FIG. 16, may display the image 1610 of the user in a picture in picture (PIP) form while displaying the partial image 1630.

If the intensity of a voice of the user is greater than that of a peripheral noise, the controller 180 can again change the partial image 1630 of the omnidirectional image to the image 1610 of the user. That is, if the intensity of the voice of the user is greater than that of the peripheral noise, the controller 180 can determine that the camera change condition has been detected.

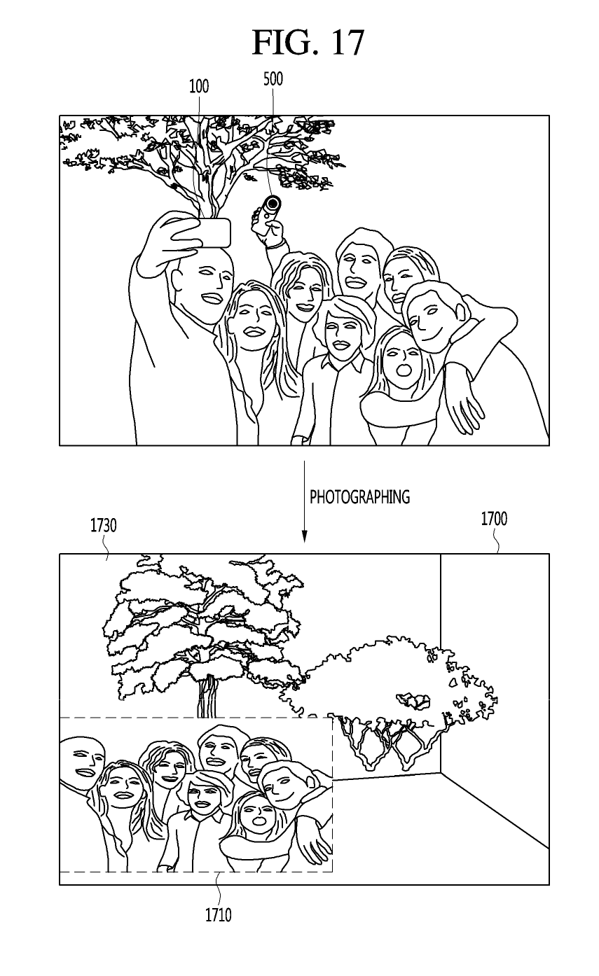

According to another embodiment of the present invention, an omnidirectional image may be photographed by simultaneously using the camera 121 provided in the mobile terminal 100 and the omnidirectional photographing device 500. For example, FIG. 17 is a view illustrating an example in which one photographing image is generated using both of the camera provided in the mobile terminal and the omnidirectional photographing device according to an embodiment of the present disclosure.

Referring to FIG. 17, the user is photographing an omnidirectional background through the mobile terminal 100 and the omnidirectional photographing device 500. The controller 180 of the mobile terminal 100 can acquire an image 1710 of people photographed through the camera 121. In addition, the controller 180 can receive an omnidirectional image of an omnidirectional background from the omnidirectional photographing device 500.

The controller 180 can extract a background image 1730 except the image 1710 of the people from the omnidirectional image. The controller 180 can synthesize the image 1710 of the people and the background image 1730, which are acquired by the controller 180, and generate a synthesized fine image 1700. The generated final image 1700 may be a combination of a two-dimensional image of the people and a two-dimensional background image, which are photographed through the mobile terminal 100.

As another example, the generated final image may be a combination of the three-dimensional background image 1730 and the image 1710 of the people, which is converted into a three-dimensional form. Since the entire omnidirectional background cannot be photographed through the camera 121 provided in the mobile terminal 100, an image contained in an omnidirectional background can be acquired by auxiliarily using the omnidirectional photographing device 500.

The present invention mentioned in the foregoing description may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

The foregoing embodiments are merely exemplary and are not to be considered as limiting the present invention. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

1. A mobile terminal comprising:
a display;
a camera configured to photograph an image of a subject;
a short-range communication processor configured to receive an omnidirectional image from an omnidirectional photographing device; and
a controller configured to:
detect a camera change condition,
change a main agent of photographing the subject to any one of the camera and the omnidirectional photographing device in response to the detected camera change condition, and
display an image photographed by the camera or the omnidirectional photographing device, which is changed as the main agent of photographing the subject, through the display.

2. The mobile terminal according to claim 1, wherein the controller is further configured to:
display the omnidirectional image received from the omnidirectional photographing device on the display, and
in response to the detected camera change condition, change the omnidirectional image to the image of the subject photographed by the camera.

3. The mobile terminal according to claim 2, wherein the controller is further configured to:
detect the camera change condition when a distance between the omnidirectional photographing device and the subject is less than a reference distance.

4. The mobile terminal according to claim 3, wherein the controller is further configured to:
in response to the detected camera change condition, receive a camera change request from the omnidirectional photographing device, and
output a vibration or voice in response to the received camera change request.

5. The mobile terminal according to claim 2, wherein the controller is further configured to:
detect the camera change condition when an image of a body of a user or an image of the mobile terminal is included in a partial image displayed on the display in the omnidirectional image photographed by the omnidirectional photographing device.

6. The mobile terminal according to claim 2, wherein the controller is further configured to:
in response to the detected camera change condition, transmit, to the omnidirectional photographing device, a camera change request for turning off power of a front camera and a rear camera, which are included in the omnidirectional photographing device.

7. The mobile terminal according to claim 1, wherein the controller is further configured to:
display the image photographed by the camera on the display, and
in response to the detected camera change condition, change the image of the subject to the omnidirectional image photographed by the omnidirectional photographing device.

8. The mobile terminal according to claim 7, wherein the controller is further configured to:
detect the camera change condition when a zoom-out command is received on the display.

9. The mobile terminal according to claim 7, wherein the controller is further configured to:
detect the camera change condition when a height of the omnidirectional photographing device is higher than that of the mobile terminal with reference to the ground.

10. The mobile terminal according to claim 7, wherein the controller is further configured to:
detect the camera change condition when a distance between the mobile terminal and the subject is equal to or greater than a reference distance.

11. A method of controlling a mobile terminal, the method comprising:
photographing, via a camera of the mobile terminal, an image of a subject;
receiving, via a short-range communication processor of the mobile terminal, an omnidirectional image from an omnidirectional photographing device;
detecting, via a controller of the mobile terminal, a camera change condition;
changing, via the controller, a main agent of photographing the subject to any one of the camera and the omnidirectional photographing device in response to the detected camera change condition; and
displaying a display of the mobile terminal.

12. The method according to claim 11, further comprising:
displaying the omnidirectional image received from the omnidirectional photographing device on the display; and
in response to the detected camera change condition, changing the omnidirectional image to the image of the subject photographed by the camera.

13. The method according to claim 12, further comprising:
detecting the camera change condition when a distance between the omnidirectional photographing device and the subject is less than a reference distance.

14. The method according to claim 13, further comprising:
in response to the detected camera change condition, receiving a camera change request from the omnidirectional photographing device; and
outputting a vibration or voice in response to the received camera change request.

15. The method according to claim 12, further comprising:
detecting the camera change condition when an image of a body of a user or an image of the mobile terminal is included in a partial image displayed on the display in the omnidirectional image photographed by the omnidirectional photographing device.

16. The method according to claim 12, further comprising:
in response to the detected camera change condition, transmitting, to the omnidirectional photographing device, a camera change request for turning off power of a front camera and a rear camera, which are included in the omnidirectional photographing device.

17. The method according to claim 11, further comprising:
displaying the image photographed by the camera on the display; and
in response to the detected camera change condition, changing the image of the subject to the omnidirectional image photographed by the omnidirectional photographing device.

18. The method according to claim 17, further comprising:
detecting the camera change condition when a zoom-out command is received on the display.

19. The method according to claim 17, further comprising:
detecting the camera change condition when a height of the omnidirectional photographing device is higher than that of the mobile terminal with reference to the ground.

20. The method according to claim 17, further comprising:
detecting the camera change condition when a distance between the mobile terminal and the subject is equal to or greater than a reference distance.
